(19) United States
(12) Patent Application Publication
(10) Pub. No.: US 2025/0028988 A1
(43) Pub. Date: Jan. 23, 2025

(54) AMPLITUDE ESTIMATION METHOD

(71) Applicants: MIZUHO RESEARCH & TECHNOLOGIES, LTD., Tokyo (JP); Mizuho Financial Group, Inc., Tokyo (JP)

(72) Inventors: Kohei OSHIO, Tokyo (JP); Shumpei UNO, Tokyo (JP)

(21) Appl. No.: 18/760,416

(22) Filed: Jul. 1, 2024

(30) Foreign Application Priority Data
Jul. 4, 2023 (JP) 2023-110102

(51) Int. Cl. G06N 10/20

(52) U.S. Cl. CPC G06N 10/20

(57) ABSTRACT

A variational quantum circuit adjusts a measurement basis for a quantum state after an amplitude has been amplified. An initial value of a parameter θ′ in the variational quantum circuit is set. A parameter θ and a noise parameter p, which indicates an intensity of noise generated in an operation, are estimated by performing a preliminary measurement of the quantum state using the variational quantum circuit in which the initial value has been set. The variational quantum circuit that adjusts the measurement basis is reconstructed by employing, as the parameter θ′, an estimated value obtained from a result of the preliminary measurement. The reconstructed variational quantum circuit is used to perform a subsequent measurement using the adjusted measurement basis. The parameter θ and the noise parameter p are estimated using a result of the subsequent measurement.

### CROSS-REFERENCE TO RELATED APPLICATIONS

The present application claims priority to Japanese Patent Application No. 2023-110102 filed on Jul. 4, 2023, the disclosure of which is incorporated herein by reference in its entirety.

### BACKGROUND

### 1. Field

The present disclosure relates to an amplitude estimation method for estimating, using a quantum computer in which noise is present, the amplitudes of quantum states realized on the quantum computer.

### 2. Description of Related Art

By using a quantum computer, it is expected that problems which could not be solved within realistic timeframes or scales with conventional computers can now be addressed. Consequently, various application technologies utilizing quantum computers are being considered (for example, see Japanese Laid-Open Patent Publication No. 2017-59074).

The amplitude estimation problem, which involves estimating parameters embedded in the amplitudes of quantum states, is one of the representative problems in quantum computers. For instance, the amplitude estimation problem can arise as a sub-problem when performing derivative pricing computations in the financial field or energy computations in the chemical field on a quantum computer.

There is room for improvement in the amplitude estimation method for estimating the amplitudes of quantum states realized on quantum computers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides an amplitude estimation method. The amplitude estimation method includes executing, by processing circuitry, operations. The operations include performing an operation of embedding a parameter θ into an amplitude in a quantum state using an operator A. The operations include amplifying, using a Grover operator, the amplitude in the quantum state on which the embedding operation has been performed by the operator A. The operations include measuring the quantum state after the amplitude has been amplified by the Grover operator. The operations include estimating the parameter θ and a noise parameter p using a result obtained by measuring the quantum state, the noise parameter p indicating an intensity of noise generated in an operation. The operation includes constructing a variational quantum circuit that adjusts a measurement basis for the quantum state after the amplitude has been amplified. The variational quantum circuit is controlled by a parameter θ′ and a parameter α. The operations include setting an initial value of the parameter θ′ in the variational quantum circuit. The operations include estimating the parameter θ and the noise parameter p by performing a preliminary measurement of the quantum state using the variational quantum circuit in which the initial value has been set. The operations include reconstructing the variational quantum circuit that adjusts the measurement basis by employing, as the parameter θ′, an estimated value obtained from a result of the preliminary measurement. The operations include performing, using the reconstructed variational quantum circuit, a subsequent measurement using the adjusted measurement basis. The operations include estimating the parameter θ and the noise parameter p using a result of the subsequent measurement.

Specifically, the above aspect is achieved by performing a total of three computations; namely, a pre-computation for adjusting the parameter α of the variational quantum circuit, a preceding computation for estimating the parameter θ, and a subsequent computation. First, the parameter α of the variational quantum circuit is adjusted by the pre-computation so as to give a desired operation in an approximate manner. Next, as the preceding computation, a rough estimated value of the parameter θ embedded in the amplitude is obtained with a relatively small number of shots. Finally, in the subsequent computation, the measurement basis is adjusted using the estimated values of the parameter α of the variational quantum circuit and the amplitude parameter θ to obtain a final estimated value of the parameter θ.

Other features and aspects will be apparent from the following detailed description, the drawings, and the claims.

### BRIEF DESCRIPTION OF THE DRAWINGS

FIG. 1 is a schematic diagram of a system according to an embodiment.

FIG. 2 is a diagram illustrating a hardware construction of the embodiment in the user terminal or the arithmetic device shown in FIG. 1.

FIG. 3 is a diagram illustrating a procedure of processes in the embodiment executed by the arithmetic device shown in FIG. 2.

FIG. 4 is a diagram illustrating the quantum circuit in the embodiment for which the procedure of processes in FIG. 3 is executed, where section (a) shows a circuit using an operator B503, section (b) shows a circuit using an operator B513, and section (c) shows a circuit using an operator B523.

FIG. 5 is a diagram illustrating the quantum circuit in the embodiment for the operator B(θ′) shown in section (a) of FIG. 4.

FIG. 6 is a diagram illustrating the quantum circuit in the embodiment, where section (a) illustrates the first gate shown in FIG. 5, and section (b) illustrates the second gate shown in FIG. 5.

FIG. 7 is a detailed diagram illustrating the procedure of processes in the embodiment explained in FIG. 3.

FIG. 8 is a diagram illustrating the quantum circuit in the embodiment.

FIG. 9 is a diagram illustrating the quantum circuit in the embodiment to which a Z-gate is added to the circuit shown in FIG. 8.

FIG. 10 is a diagram illustrating the quantum circuit in the embodiment to which Ry(−2Ngθ′−π/2) is added to the circuits shown in FIGS. 8 and 9 as the operator B(θ′) indicating section (a) of FIG. 4.

FIG. 11 is a diagram illustrating the quantum circuit in the embodiment.

FIG. 12 is a diagram illustrating the advantages of the embodiment.

FIG. 13 is a diagram illustrating a quantum circuit used for verification in the embodiment.

FIG. 14 is a diagram illustrating the quantum circuit in the embodiment.

FIG. 15 is a diagram illustrating a general quantum circuit.

FIG. 16 is a diagram illustrating a general procedure of processes.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B. or both A and B.”

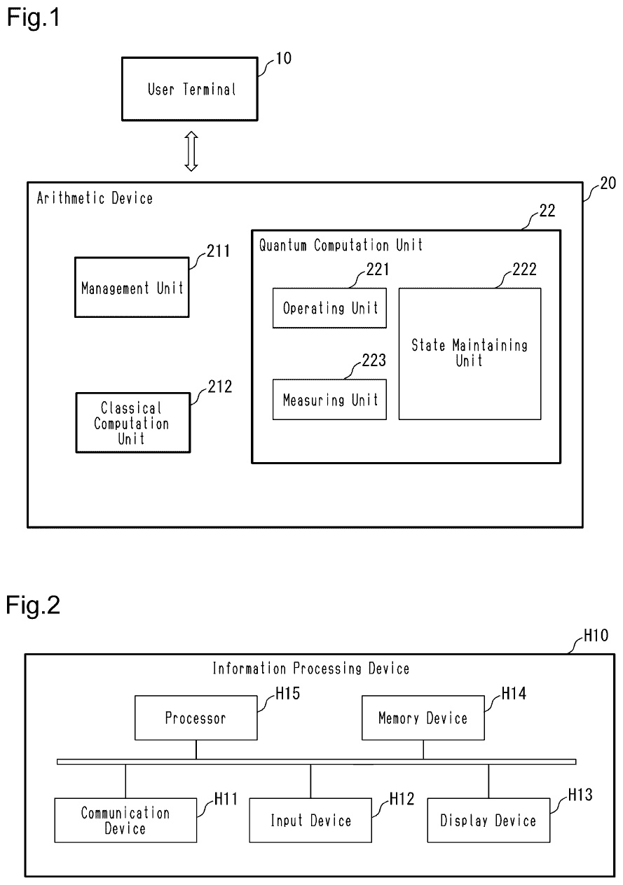

An amplitude estimation method according to an embodiment will now be described with reference to FIGS. 1 to 16. In the present embodiment, a parameter θ is estimated in a situation where a parameter p indicating the intensity of noise is unknown. The parameter θ is embedded in the amplitude in the quantum state by an operator A.

The amplitude estimation problem is a problem of estimating the parameter θ embedded in the amplitude of the state |ψ(θ)>ₙ₊₁ in the following Expression 1. Expression 1 is defined using the operator A. The operator A performs an operation defined by Expression 1.

$${{{{A \vert 0 〉}_{n + 1} = \vert ψ ( θ ) 〉}_{n + 1} = cos ( θ ) \vert {ψ}_{0} )}_{n} \vert 0 〉 + sin ( θ ) \vert {ψ}_{1} 〉}_{n} \vert 1 〉 , 0 \leq θ \leq \frac{π}{2} \qquad [ Expression 1 ]$$

The operation using a Grover operator G for the quantum state of Expression 1, which is shown in the fourth equation of Expression 2, is referred to as amplitude amplification.

$$\begin{matrix}G = {AU}_{0} {A}^{†} {U}_{\text{?}} \\ {{U}_{0} = - {I}_{n + 1} + 2 \vert 0 〉}_{n + 1} 〈 0 {\vert}_{n + 1} \\ {U}_{f} = - {I}_{n + 1} + 2 {I}_{n} ⊗ \vert 0 〉 〈 0 \vert \\ {{{{{G}^{m} \vert ψ ( θ ) 〉}_{n + 1} = \vert ψ ( ( 2 m + 1 ) θ ) 〉}_{n + 1} = cos ( {N}_{g} θ ) \vert {ψ}_{0} 〉}_{n} \vert 0 ) + sin ( {N}_{g} θ ) \vert {ψ}_{1} 〉}_{n} \vert 1 〉\end{matrix} \qquad [ Expression 2 ]$$

$$\text{?} \text{indicates text missing or illegible when filed}$$

Where Ng=2m+1

Here, m is the number of amplitude amplifications. That is, m is the number of calls to the Grover operator G. Further, Ng=2m+1 is the number of calls to the operator A when the operation shown in the circuit of FIG. 15 is executed once.

As amplitude estimation using amplitude amplification, a method for using maximum likelihood estimation when estimating amplitude is known (refer to Japanese Patent No. 7005806). The technique described in this document estimates an amplitude by performing maximum likelihood estimation. This maximum likelihood estimation is performed based on combinations of measurement data generated from quantum circuits each having a different number of calls to the Grover operator G (i.e., a different number of amplitude amplification operations).

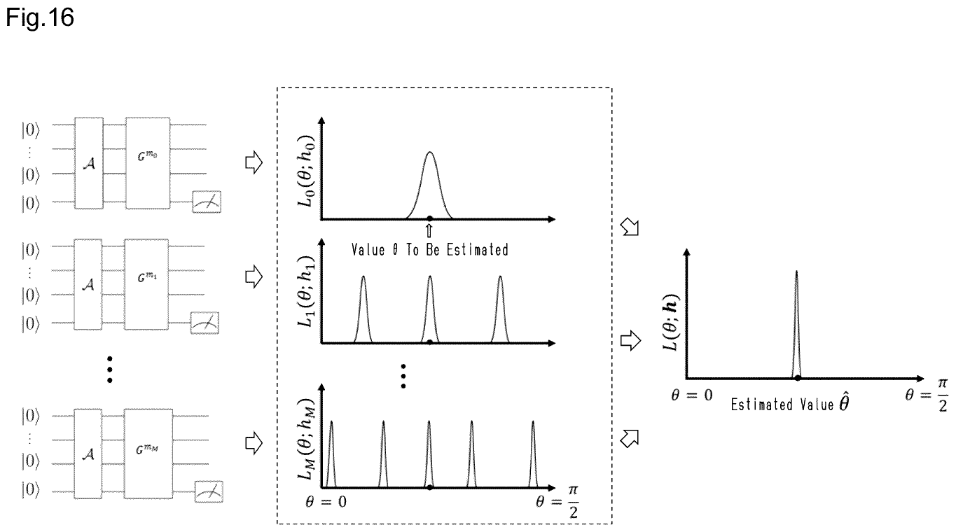

As shown in FIG. 16, in amplitude estimation using maximum likelihood estimation, each quantum circuit performs amplitude amplification by applying the Grover operator G a different number of times m1, m2, . . . , mM. Each quantum circuit then performs measurements with a certain number of repetitions (i.e., shots N). Then, by using maximum likelihood estimation for the measurement result, an estimated value θ that maximizes the likelihood is obtained. A noise-free quantum computer, using amplitude estimation with maximum likelihood estimation, shows the best estimation accuracy when the number of calls to the operator A is constant. When the number of shots N is sufficiently large, the theoretical limit of estimation accuracy is almost achieved (see the above-mentioned Japanese Patent No. 7005806).

A quantum state is usually disturbed by noise resulting from the interaction between the system and the environment. The influence of such noise is modeled by a model in which depolarization noise is generated each time the Grover operator is operated, for example, as in Expression 3. Here, ρₙₒᵢₛₑ is a density operator representing the quantum state after depolarization noise has occurred. In this model, it is assumed that, in accordance with a noise parameter p that gives the intensity of noise, a correct operation is performed with a probability p, and a completely mixed state is obtained with a probability [1-p]. The value of the noise parameter p is unknown because it varies depending on the details of the operation. However, since the measurement result changes depending on the noise parameter p, the influence of the noise parameter p needs to be considered in order to accurately estimate the parameter θ. Here, d=2⁽ⁿ⁺¹⁾ represents the dimension of the Hilbert space.

$$\begin{matrix}{{ρ}_{n o i s e} ( {N}_{g} θ ) = {p}^{m} \vert ψ ( {N}_{g} θ ) 〉}_{n + 1} 〈 ψ ( {N}_{g} θ ) {\vert}_{n + 1} + ( 1 - {p}^{m} ) \frac{{I}_{n + 1}}{d} \\ {N}_{g} = 2 m + 1 \\ {{\vert ψ ( {N}_{g} θ ) 〉 = cos {N}_{g} θ \vert {ψ}_{0} 〉}_{n} \vert 0 〉 + sin {N}_{g} θ \vert {ψ}_{1} 〉}_{n} \vert 1 〉\end{matrix}$$

In the estimation of the parameter θ, it is known that a measurement basis that theoretically allows for the most accurate estimation of θ is obtained by spectral decomposition of a SLD operator L^{S} (see Braunstein, S. L. et al., “Statistical Distance and the Geometry of Quantum States,” PHYSICAL REVIEW LETTERS, 72, American Physical Society, May 30, 1994, https://painterlab.caltech.edu/wp-content/uploads/2019/06/statistical_distance_geometry_quantum_states.pdf). Here, the measurement basis indicates a state serving as a reference in measurement of a quantum state.

In this problem setting, the eigenvectors of the SLD operator L^{S} are given by λ₀, λ₁, and λ_{d} in the following formula. Here, |d> is a vector orthogonal to |ψ₀> and |ψ₁>.

$$\begin{matrix}{{\vert {λ}_{0} ( θ ; m ) 〉 = cos ( {N}_{g} θ + \frac{π}{4} ) \vert {ψ}_{0} 〉}_{n} \vert 0 〉 + sin ( {N}_{g} θ + \frac{π}{4} ) \vert {ψ}_{1} 〉}_{n} \vert 1 〉 \\ {{\vert {λ}_{1} ( θ ; m ) 〉 = - sin ( {N}_{g} θ + \frac{π}{4} ) \vert {ψ}_{0} 〉}_{n} \vert 0 〉 + cos ( {N}_{g} θ + \frac{π}{4} ) \vert {ψ}_{1} 〉}_{n} \vert 1 〉 \\ \vert {λ}_{d} 〉 = \vert d 〉\end{matrix} \qquad [ Expression 4 ]$$

If measurements can be performed in the measurement basis including the eigenvectors λ₀, λ₁, λ_{d}, it is theoretically possible to estimate the parameter θ with the highest accuracy. To perform measurements with an arbitrary measurement basis on a quantum computer, it is generally necessary to perform a large number of gate operations before the measurement.

As a method for adjusting the measurement direction with a relatively small number of operations, a variational quantum circuit may be used. A variational quantum circuit uses gate operations controlled by parameters. By employing such circuits, it is expected to give an operation approximate to the desired operation with relatively few gate operations. For example, variational quantum circuits that are relatively easy to implement on hardware, have been proposed for the physical constraints of quantum computers. These include, for example, Hardware Efficient Ansatz and Alternating Layered Ansatz (see A. Kandala et al., “Hardware-efficient variational quantum eigensolver for small molecules and quantum magnets,” Nature, 549, 242-246 (2017), Springer Nature Limited. Apr. 17, 2017, https://arxiv.org/pdf/1704.05018.pdf and M. Cerezo et al., “Cost function dependent barren plateaus in shallow parametrized quantum circuits,” Nature Communications, volume 12, Article number: 1791 (2021), Mar. 19, 2021, https://www.nature.com/articles/s41467-021-21728-w).

As mentioned above, the optimal measurement basis in the presence of noise can be obtained through the spectral decomposition of the SLD operator L^{S}. However, in quantum computers, measurements are performed using a specific measurement basis referred to as the computational basis, making it difficult to achieve the theoretical limit of estimation accuracy for the parameter θ.

The present embodiment adopts an adaptive measurement basis optimization strategy that allows for achieving the theoretical limit of estimation accuracy in the estimation of the parameter θ. Here, the parameter estimation is divided into two stages. Specifically, first, the parameters θ and p are roughly estimated from the measurement results obtained in a preliminary measurement. Then, the measurement basis is optimized using this result, and a subsequent measurement is performed, thereby obtaining final estimated values of the parameters θ and p.

Thus, a user terminal 10 and an arithmetic device 20 connected to each other via a network as shown in FIG. 1 are used.

### Description of Hardware Construction

A hardware construction of an information processing device H10 will now be described with reference to FIG. 2. The information processing device H10 serves as the user terminal 10 or the arithmetic device 20. The arithmetic device 20 includes a management unit 211 and a classical computation unit 212. The information processing device H10 includes a communication device H11, an input device H12, a display device H13, a memory device H14, and a processor H15. This hardware construction is merely an example, and may be implemented by other hardware.

The communication device H11 is an interface that establishes communication paths with other devices to send and receive data. The communication device H11 is, for example, a network interface or a wireless interface.

The input device H12 is a device that accepts inputs from a user or the like and is, for example, a mouse or a keyboard. The display device H13 is, for example, a display that displays various types of information.

The memory device H14 stores data and various programs to implement the functions of the user terminal 10 or the arithmetic device 20. Examples of the memory device H14 include a ROM, a RAM, and a hard disk.

The processor H15 uses the programs and data stored in the memory device H14 to control processes in the user terminal 10 or the arithmetic device 20. Examples of the processor H15 include a CPU and a MPU. The processor H15 deploys programs stored in a ROM or the like with a RAM to execute various processes providing service.

The processor H15 does not have to execute all processes through software processing. For example, the processor H15 may include a special-purpose hardware circuit, such as an application-specific integrated circuit (ASIC) that executes at least some processes through hardware processing. Specifically, the processor H15 may be circuitry (e.g., processing circuitry) including any of the following.
(1) One or more processors that operate according to a computer program;
(2) One or more dedicated hardware circuits that execute at least part of various processes; and
(3) A combination thereof.

The processor includes a CPU and memory such as a RAM and ROM. The memory stores program codes or instructions constructed to cause the CPU to execute the processes. The memory, which is a computer-readable storage medium, includes any type of non-transitory storage media that are accessible by general-purpose computers and dedicated computers. In other words, one or more computer-readable storage media store instructions that, when executed by one or more computer processors, cause the one or more computer processors to perform various operations.

### System Construction of Arithmetic Device 20

The system construction of the user terminal 10 and the arithmetic device 20 will now be described with reference to FIG. 1.

The user terminal 10 is a computer terminal used by a user.

The arithmetic device 20 is a computer for performing amplitude estimation.

The arithmetic device 20 executes processes that will be described below (processes such as a management stage, a classical computation stage, and a quantum computation stage). By executing programs for these processes, the arithmetic device 20 functions as the management unit 211, the classical computation unit 212, and a quantum computation unit 22.

The management unit 211 manages quantum computations and classical computations.

The classical computation unit 212 performs a statistical process in the maximum likelihood estimation. Further, the classical computation unit 212 executes an updating process that updates the parameters used to optimize the measurement basis.

The quantum computation unit 22 performs quantum computations. The quantum computation unit 22 includes an operating unit 221, a state maintaining unit 222, and a measuring unit 223.

The operating unit 221 performs a quantum operation according to a program, on qubits of the state maintaining unit 222. In this case, the operating unit 221 operates (creates) the state maintained by the state maintaining unit 222 using a quantum circuit including, for example, quantum gates.

The state maintaining unit 222 includes multiple qubits and maintains an arbitrary quantum state. Each qubit maintains a superposition state of multiple values in an arbitrary physical state such as an electron level, an electron spin, an ion level, each spin, and/or a photon. The qubit is not limited to the above if the superposition state can be maintained.

The measuring unit 223 observes the eigenstate of the superposition state of the qubits of the state maintaining unit 222. The measuring unit 223 records the hit count according to the states of the qubits in the state maintaining unit 222.

### Outline of Parameter Estimation Process

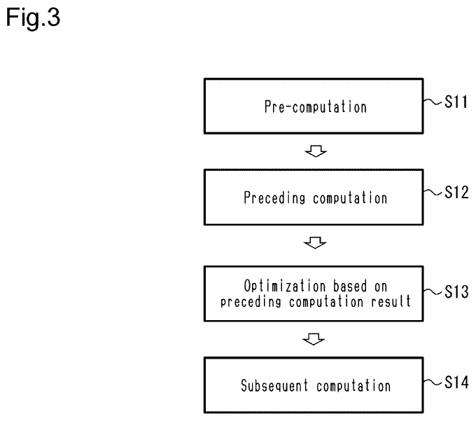

The outline of the parameter estimation process will now be described with reference to FIGS. 3 to 6.

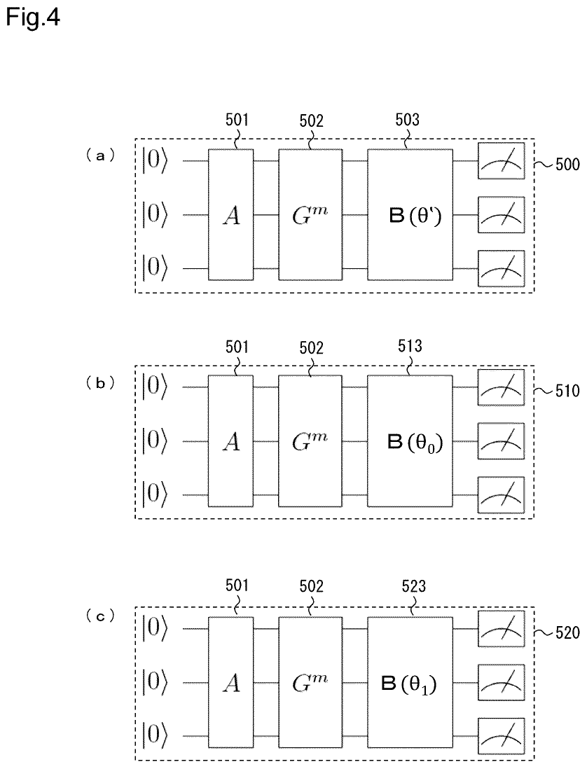

Section (a) of FIG. 4 shows a quantum circuit 500 including an operator A(501), a Grover operator G(502), and an operator B(θ′)(503). In the following parameter estimation process, a parameter is estimated by performing amplitude estimation using maximum likelihood estimation on the quantum circuit 500. The operator B(θ′) is used to adjust the measurement basis. The operator B(θ′) is controlled by the parameter θ′. As shown in Expression 5, the operator B(θ′) ideally transforms the eigenvectors λ₀ and κ₁ into computational bases |0>ₙ|0> and |0>ₙ|1>, respectively.

$$\begin{matrix}{{{B ( {θ}^{′} ) \vert {λ}_{0} ( θ ; 0 ) 〉 = B ( {θ}^{′} ) ( cos ( θ + \frac{π}{4} ) \vert {ψ}_{0} 〉}_{n} \vert 0 〉 + sin ( θ + \frac{π}{4} ) \vert {ψ}_{1} 〉}_{n} \vert 1 〉 ) = \vert 0 〉}_{n} \vert 0 〉 \\ {{{B ( {θ}^{′} ) \vert {λ}_{1} ( θ ; 0 ) 〉 = B ( {θ}^{′} ) ( - sin ( θ + \frac{π}{4} ) \vert {ψ}_{0} 〉}_{n} \vert 0 〉 + cos ( θ + \frac{π}{4} ) \vert {ψ}_{1} 〉}_{n} \vert 1 〉 ) = \vert 0 〉}_{n} \vert 1 〉\end{matrix} \qquad [ Expression 5 ]$$

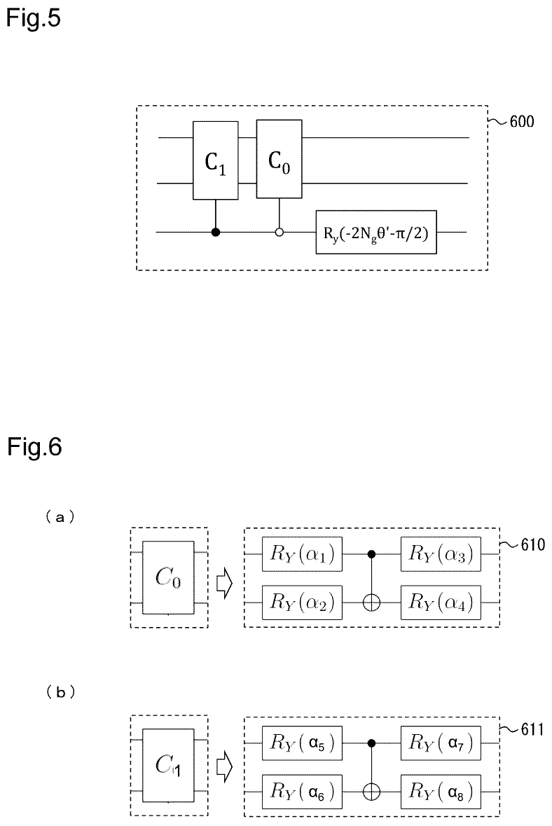

As shown in FIG. 5, a quantum circuit 600 may be used as a detailed breakdown of the operator B(θ′). The quantum circuit 600 is divided into an operator C₀ (first gate), an operator C₁ (second gate), and a Ry gate. n qubits are input to each of the operators C₀ and C₁. The Ry gate is used to perform a rotation operation around the y-axis on the Bloch sphere when focusing on the control bit.

The operators C₀ and C₁ satisfy the following conditions.

$${{{{{C}_{0} \vert {ϕ}_{0} 〉}_{n} = 0 〉}_{n} , {C}_{1} \vert {ϕ}_{1} 〉}_{n} = \vert 0 〉}_{n} \qquad [ Expression 6 ]$$

It is assumed that the operators C₀ and C₁ satisfying the condition of Expression 6 are approximately constructed using a variational quantum circuit controlled by a parameter α. The variational quantum circuit may have any construction. Specifically, the variational quantum circuit can use Hardware Efficient Ansatz described in “Hardware-efficient variational quantum eigensolver for small molecules and quantum magnets,” Nature, 549, 242-246(2017), Springer Nature Limited, Apr. 17, 2017, https://arxiv.org/pdf/1704.05018.pdf, in addition to the aforementioned A. Kandala et al. Additionally, the variational quantum circuit can also use Alternating Layered Ansatz described in “Cost function dependent barren plateaus in shallow parametrized quantum circuits,” Nature Communications, volume 12, Article number: 1791(2021), Mar. 19, 2021, https://www.nature.com/articles/s41467-021-21728-w, in addition to the aforementioned M. Cerezo et al.

For example, the operators C₀ and C₁ when n=2 will be described.

As shown in sections (a) and (b) of FIG. 6, quantum circuits 610 and 611 may be used as the operators C₀ and C₁, respectively. The operator C₀ can be constructed by a Ry gate including parameters α1 to α4. The operator C₁ can be constructed by a Ry gate including parameters α5 to α8.

According to the outline of the procedure shown in FIG. 3, the parameter θ is estimated using the above-described quantum circuit. As described above, the operators C₀ and C₁ are constructed using variational quantum circuits. First, the parameter α of the variational quantum circuit is adjusted by pre-computation to give a desired operation in an approximate manner to the operators C₀ and C₁ (step S11).

Next, the arithmetic device 20 executes a preceding computation process (step S12). Specifically, the management unit 211 performs amplitude estimation by maximum likelihood estimation using the classical computation unit 212 and the quantum computation unit 22.

### Preceding Computation Process

As shown in section (b) of FIG. 4, in the preceding computation process, first, the quantum circuit 510 is constructed. The quantum circuit 510 uses an operator A (operator A501), an operator G^{m} (Grover operator 502), and an operator B(θ₀) (operator B513). The parameter θ₀ included in the operator B513 is an initial value of a parameter θ′ included in the operator B503. As will be described later, an appropriate value is set to the parameter θ₀. Then, the management unit 211 records the preceding measurement result by performing measurements while changing the number m of calls to the Grover operator and executing operations No times by the quantum computation unit 22. Thereafter, from the obtained preceding measurement result, amplitude estimation is performed by maximum likelihood estimation described in the above-mentioned Japanese Patent No. 7005806. As a result, the management unit 211 obtains θ₁ as the estimated value of the parameter θ.

Next, the arithmetic device 20 executes a process that optimizes the measurement basis (step S13). Here, the operator B523 for adjusting the measurement basis is constructed using the parameter θ₁ obtained in the preceding computation process.

Then, the arithmetic device 20 executes a subsequent computation process (step S14). In this case as well, the management unit 211 performs amplitude estimation by maximum likelihood estimation using the classical computation unit 212 and the quantum computation unit 22.

### Subsequent Computation Process

As shown in section (c) of FIG. 4, in the subsequent computation process, first, the quantum circuit 520 is constructed. The quantum circuit 520 uses the operator A (operator A501), the operator G^{m} (Grover operator 502), and an operator B(θ₁) (operator B523). In the same manner as the preceding computation process, the management unit 211 records the subsequent measurement result by performing measurements while changing the number m of calls to the Grover operator and executing operations N₁ times by the quantum computation unit 22. Thereafter, from the obtained subsequent measurement result, amplitude estimation is performed by the maximum likelihood estimation described in the above-mentioned Japanese Patent No. 7005806. As a result, the management unit 211 obtains θ₂ as the estimated value of the parameter θ.

### Specific Processes of Parameter Estimation Process

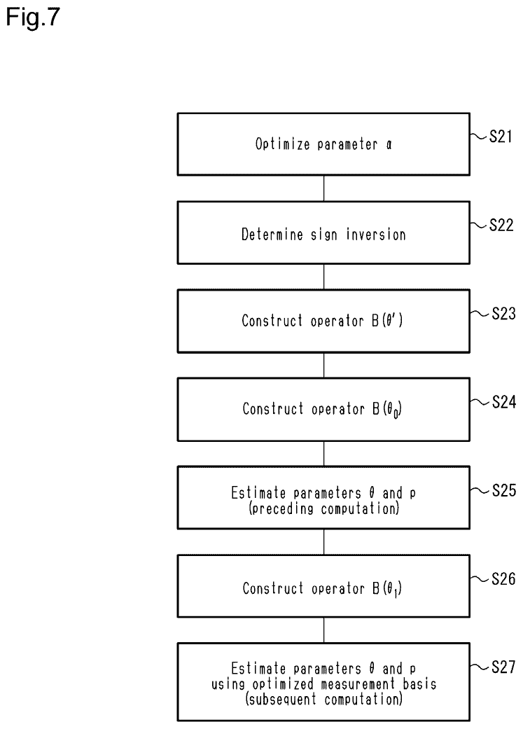

The processes of FIG. 3 will now be described in more detail with reference to FIG. 7.

First, the arithmetic device 20 optimizes the parameter α for controlling the operators C₀ and C₁ (step S21). The parameters α1 to α8 are optimized by constructing the operators C₀ and C₁ as shown in FIG. 6 such that the variational quantum circuit perform a desired operation. In this case, the parameters α1 to α8 are optimized to satisfy the condition indicated in the following Expression 7.

$$\begin{matrix}{{{C}_{0} ( {α}_{1} , {α}_{2} , {α}_{3} , {α}_{4} ) \vert {ψ}_{0} 〉}_{η} = \vert 0 〉}_{n} , & {{{C}_{1} ( {α}_{5} , {α}_{6} , {α}_{7} , {α}_{8} ) \vert {ψ}_{1} 〉}_{η} = \vert 0 〉}_{n}\end{matrix} \qquad [ Expression 7 ]$$

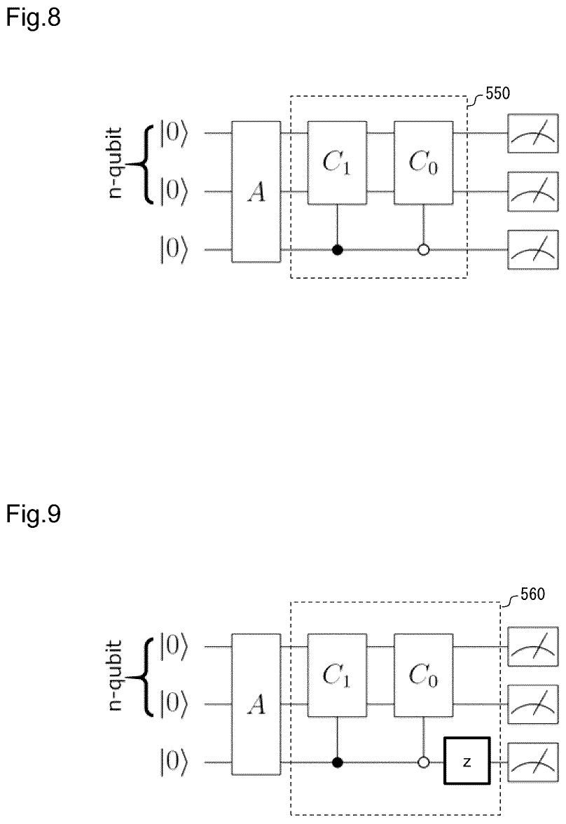

As shown in FIG. 8, the operators C₀ and C₁ are combined to construct an operator B′ (quantum circuit 550). As a cost function, the number of times each bit indicated as an n-qubit in the measurement results of the quantum circuit shown in FIG. 8 did not turn to 0 is counted. Here, the lowermost bit in FIG. 8 is a control bit. The white circle in FIG. 8 means that the gate operation (C₀) attached to the white circle is executed when the control bit is 0. The black circle in FIG. 8 means that the gate operation (C₁) attached to the black circle is executed when the control bit is 1. The measurement result used to optimize the parameter α can be used to estimate the parameter θ.

Next, the arithmetic device 20 determines whether the sign is inverted (step S22). B′|ψ(θ)> provide a transformation into states with opposite signs, as shown in the following Expression 8.

$${{{B}^{′} \vert ψ ( θ ) 〉 = cos θ \vert 0 〉}_{n} \vert 0 〉 \pm sin θ \vert 0 〉}_{n} \vert 1 〉 \qquad [ Expression 8 ]$$

Thus, when transformation is performed as shown in the following Expression 9, bit inversion by the Z-gate is required.

$${{{B}^{′} \vert ψ ( θ ) 〉 = cos θ \vert 0 〉}_{n} \vert 0 〉 - sin θ \vert 0 〉}_{n} \vert 1 〉 \qquad [ Expression 9 ]$$

To determine the sign inversion, measurement is performed by adding an H-gate as shown in Expression 10.

$${{{HB}^{′} \vert ψ ( θ ) 〉 = H \{ cos θ \vert {ψ}_{0} 〉}_{n} \vert 0 〉 + sin θ \vert {ψ}_{1} 〉}_{n} \vert 1 〉 \} = \frac{1}{\sqrt{2}} {{\{ ( cos θ \pm sin θ ) \vert 0 〉}_{n} \vert 0 〉 + ( cos θ ∓ sin θ ) \vert 0 〉}_{n} \vert 1 〉 \} \qquad [ Expression 10 ]$$

In the case of (cos θ+sin θ)|0>ₙ|0>+(cos θ−sin θ)|0>ₙ|1> from 0≤θ≤π/2, the relationship of p₀>p₁ is established between the probabilities (p₀, p₁) of obtaining |0>ₙ|0> and 10>ₙ|1>. Thus, if p₀>p₁ based on the measurement results, a Z-gate is applied.

In this case, as shown in FIG. 9, a quantum circuit 560 to which a Z-gate is added is used as the operator B′ according to the sign determination result.

Subsequently, the arithmetic device 20 constructs the operator B(θ′) (step S23). The operator B(θ′) shown in FIG. 5 is constructed by adding Ry(−2Nθ′−π/2) to the operator B′ (quantum circuit 600).

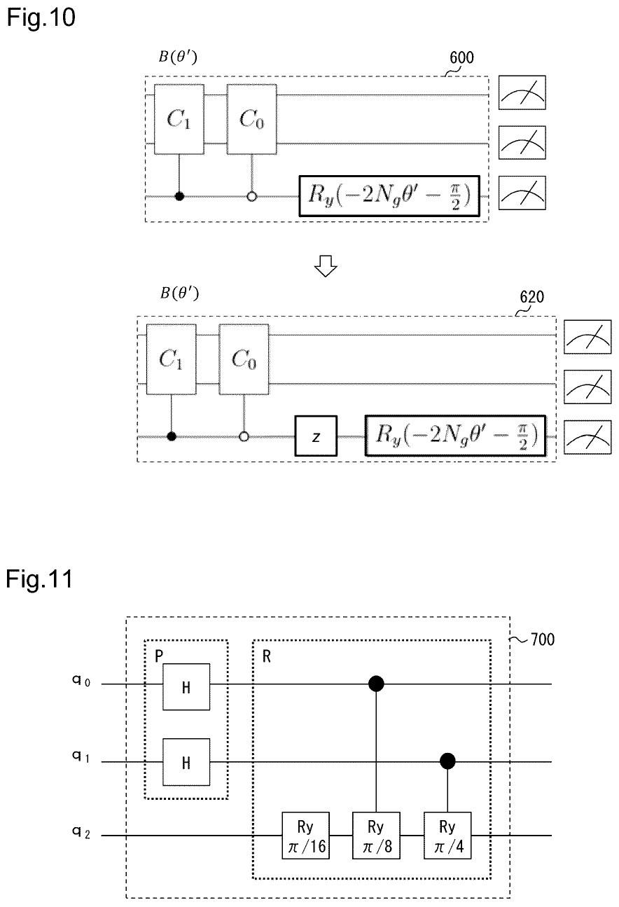

When bit inversion is required, as shown in FIG. 10, the operator B(θ′) in which not only Ry(−2Ngθ′−π/2) but also the Z-gate is added is used (quantum circuit 620).

Next, the arithmetic device 20 constructs the operator B(θ₀) (step S24). Here, an initial value θ₀ of the parameter θ′ is set. Specifically, the initial value θ₀ is set such that −2N_{R}θ₀−π/2=0 is satisfied.

Next, the arithmetic device 20 estimates the parameters θ and p (step S25). The management unit 211 uses the quantum computation unit 22 to perform No measurements for the quantum circuit 510 to which the operator B(θ₀) is added (section (b) in FIG. 4), while changing the number of amplitude amplifications (i.e., while changing the number of calls to the Grover operator G). Then, the classical computation unit 212 obtains an estimated value θ₁ of θ by estimating the parameters θ and p by amplitude estimation using maximum likelihood estimation.

Then, the arithmetic device 20 constructs the operator B (θ₁) (step S26). The operator B(θ₁) is constructed by employing the estimated value θ of θ obtained from the measurement result as a new parameter θ₁.

Next, the parameters θ and p are estimated using the optimized measurement basis (step S27). The management unit 211 uses the quantum computation unit 22 to perform N₁ measurements for the quantum circuit 520 to which the operator B(θ₁) is added (section (c) in FIG. 4), while changing the number of amplitude amplifications (i.e., while changing the number of calls to the Grover operator G). Then, the classical computation unit 212 obtains an estimated value θ₂ of θ by estimating the parameters θ and p by amplitude estimation using maximum likelihood estimation.

The present embodiment has the following advantages.

(1) In the present embodiment, the arithmetic device 20 executes the pre-computation process (step S11), the preceding computation process (step S12), the process that optimizes the measurement basis based on the preceding computation result (step S13), and the subsequent computation process (step S14). This enables highly accurate estimation of the amplitude in the quantum state through the adaptive optimization of the measurement basis.

For example, the parameter θ that provides S as given by the following equation can be obtained.

$$\begin{matrix}{{{A \vert 0 〉}_{3} = \sqrt{1 - \overline{S}} \vert Ψ 〉}_{2} \vert 0 〉 + \sqrt{\overline{S}} \vert {Ψ}_{1} 〉}_{2} 11 〉 \\ S = {\int }_{0}^{1} {sin}^{2} ( \frac{1}{4} π x ) = 0.18169 \\ \approx \tilde{s} = {\sum }_{x = 0}^{{2}^{2} - 1} \frac{1}{{2}^{2}} {sin}^{2} ( \frac{x + \frac{1}{2}}{{2}^{2}} \cdot \frac{π}{4} ) = 0.17963 \\ sin θ = \sqrt{\tilde{S}} = \sqrt{0.17963}\end{matrix} \qquad [ Expression 11 ]$$

For this estimation, the quantum circuit 700 shown in FIG. 11 is used.

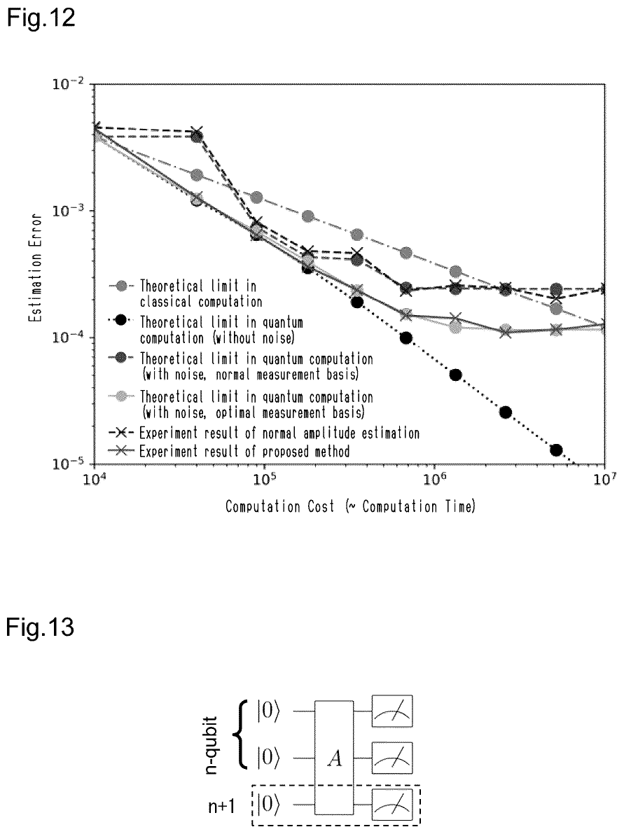

As shown in FIG. 12, this allows for actual estimation of the amplitude in the quantum state with an accuracy relatively close to the theoretical limit in a situation where noise is present.

The present disclosure allows for estimation of a parameter embedded in the amplitude of the quantum state with high accuracy in quantum computation.

(2) In the present embodiment, the arithmetic device 20 determines whether the sign is inverted (step S22). This allows the quantum circuit to be constructed in consideration of the sign inversion of the quantum state after operation of the operators C₀ and C₁ constructed with the variational quantum circuit.

(3) In the present embodiment, the amplitude in the state of the following Expression 12 is estimated in the estimation of the parameter θ.

$${{\vert ϕ ( θ ) 〉 = cos θ \vert {ϕ}_{0} 〉}_{n} 0 〉 + sin θ \vert {ϕ}_{1} 〉}_{n} \vert 1 〉 \qquad [ Expression 12 ]$$

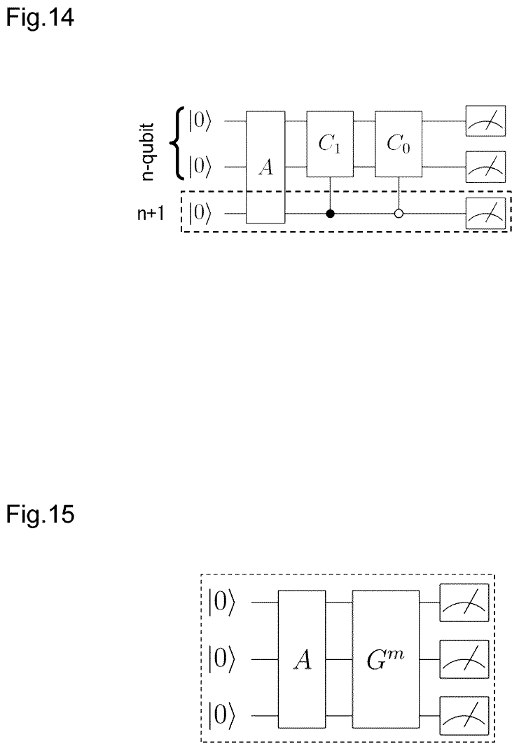

The state of the above Expression 12 is constructed by the bases |ψ₀>ₙ|0> and |ψ₁>ₙ|1>. Thus, if the output of (n+1)th qubit shown in FIG. 13 is known, the amplitude can be estimated. As shown in FIG. 14, the operators C₀ and C₁ do not affect the state of the (n+1)th qubit. Accordingly, the output of this circuit can be used to estimate the parameter θ.

The present embodiments may be modified as follows. The present embodiment and the following modifications can be combined as long as they remain technically consistent with each other.

In the present embodiment, the arithmetic device 20 executes the pre-computation process (step S11), the preceding computation process (step S12), the process that optimizes the measurement basis based on the preceding computation result (step S13), and the subsequent computation process (step S14). That is, the parameter estimation is divided into two stages. However, the number of stages is not limited to two if the measurement basis of the subsequent computation can be optimized by the preceding computation.

In the above-described embodiment, the variational quantum circuit is constructed by the operators C₀, C₁ and the Ry gate, but is not limited thereto.

In the above-described embodiment, the operators C₀ and C₁ are constructed by Ry gates, but are not limited thereto.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An amplitude estimation method comprising executing, by processing circuitry, operations comprising:
performing an operation of embedding a parameter θ into an amplitude in a quantum state using an operator A;
amplifying, using a Grover operators, the amplitude in the quantum state on which the embedding operation has been performed by the operator A;
measuring the quantum state after the amplitude has been amplified by the Grover operator G;
estimating the parameter θ and a noise parameter p using a result obtained by measuring the quantum state, the noise parameter p indicating an intensity of noise generated in an operation;
constructing a variational quantum circuit that adjusts a measurement basis for the quantum state after the amplitude has been amplified, the variational quantum circuit being controlled by a parameter θ′;
setting an initial value of the parameter θ′ in the variational quantum circuit;
estimating the parameter θ and the noise parameter p by performing a preliminary measurement of the quantum state using the variational quantum circuit in which the initial value has been set;
reconstructing the variational quantum circuit that adjusts the measurement basis by employing, as the parameter θ′, an estimated value obtained from a result of the preliminary measurement;
performing, using the reconstructed variational quantum circuit, a subsequent measurement of the quantum state using the adjusted measurement basis; and
estimating the parameter θ and the noise parameter p using a result of the subsequent measurement.

2. The amplitude estimation method according to claim 1, further comprising determining the adjusted measurement basis from an eigenvector, wherein
the eigenvector is computed by spectral decomposition of an SLD operator in a definition of an SLD quantum Fisher information matrix.

3. The amplitude estimation method according to claim 1, wherein
an operation of the variational quantum circuit is controlled by the parameter θ′, and
the amplitude estimation method further comprises adjusting the measurement basis by adjusting the parameter θ′.

4. The amplitude estimation method according to claim 1, wherein
the variational quantum circuit receives (n+1) qubits,
the variational quantum circuit includes:
a first gate C₁ that acts on n qubits when a control bit is 1, the first gate C₁ being controlled by a parameter α₁;
a second gate C₀ that acts on n qubits when the control bit is 0, the second gate C₀ being controlled by a parameter α₀; and
a Ry gate that acts on the control bit, the Ry gate being controlled by the parameter θ′, and
the amplitude estimation method further comprises optimizing a parameter α such that Expression 1 is satisfied.
$${{{{{C}_{0} ( {α}_{0} ) {ϕ}_{0} 〉}_{n} = \vert 0 〉}_{b} , {C}_{1} ( {α}_{1} ) \vert {ϕ}_{1} 〉}_{n} = \vert 0 〉}_{n} \qquad [ Expression 1 ]$$

5. The amplitude estimation method according to claim 4, further comprising:
determining the sign of the amplitude of the quantum state at an output of the variational quantum circuit; and
adding a Z-gate to the control bit according to a determination result of the sign of the amplitude of the quantum state.
